(19) United States
(12) Patent Application Publication
(10) Pub. No.: US 2025/0296206 A1
(43) Pub. Date: Sep. 25, 2025

(54) MULTI-NUT DRIVER

(71) Applicant: Klein Tools, Inc., Lincolnshire, IL (US)

(72) Inventors: Alexander Turner, Saginaw, TX (US); Austin Minor, Aledo, TX (US); Chris Mangini, Arlington, TX (US)

(73) Assignee: Klein Tools, Inc., Lincolnshire, IL (US)

(21) Appl. No.: 18/609,100

(22) Filed: Mar. 19, 2024

(51) Int. Cl. B25B 15/02; B25B 13/06; B25B 23/00; B25G 1/08

(52) U.S. Cl. CPC B25B 15/02; B25B 13/06; B25B 23/0035; B25G 1/085

(57) ABSTRACT

A multi-nut driver is includes a handle having an opening and a hollow interior. A reversible adapter is removably received in the opening of the handle. The reversible adapter includes a first retention portion at a first end and a second retention portion at a second end opposite the first end. The multi-nut driver includes a first elongated shank removably retained by the first retention portion, and a second elongated shank removably retained by the second retention portion. The multi-nut driver includes a socket removably mounted to the first elongated shank. The first elongated shank protrudes from the reversible adapter and into the hollow interior of the handle.

### BACKGROUND OF THE DISCLOSURE

The present disclosure relates to nut drivers, and more specifically to nut drivers that utilize reversible sockets. Such nut drivers are known and include nut drivers that utilize a drive shank that can receive a reversible socket in either a first orientation or a second orientation, with each orientation of the reversible socket providing a different socket size than the other orientation. It is also known for such drivers to allow the reversible socket to be mounted at two different positions along the length of the drive shank in at least one of the first or second orientations to allow the socket to drive a nut in one of the positions along the length and to receive a drive bit in the other of the positions along the length. While such known drivers are suitable for their intended purpose, there is always room for improvement, especially with respect to features and ease of use. For example, some of the currently known drivers may be limited by the number of reversible sockets and compactness of the tool.

### BRIEF SUMMARY OF THE DISCLOSURE

In accordance with one feature of this disclosure, a multi-nut driver is provided and includes a handle having an opening and a hollow interior. A reversible adapter is removably received in the opening of the handle. The reversible adapter includes a first retention portion at a first end and a second retention portion at a second end opposite the first end. The multi-nut driver includes a first elongated shank removably retained by the first retention portion, and a second elongated shank removably retained by the second retention portion. The multi-nut driver includes a socket removably mounted to the first elongated shank. The first elongated shank protrudes from the reversible adapter and into the hollow interior of the handle.

In one feature, the handle opening is a ⅞″ hex socket shaped to engage a bolt head having a hexagonal profile.

According to another feature, the reversible adapter includes a third retention portion on a side of the reversible adapter between the first end and the second end.

As one feature, the first elongated shank or the second elongated shank is removably retained by the third retention portion.

According to one feature, the third retention portion is perpendicular to the first retention portion and the second retention portion.

In accordance with one feature, the first retention portion and the second retention portion extend along a common axis. The reversible adapter further includes a third retention portion extending perpendicular to the common axis.

In another feature, the multi-nut driver includes a second socket supported along the first elongated shank, wherein the second socket is contained within the hollow interior of the handle.

In one feature, the socket is a first socket further mounted to a first end of the first elongated shank. The multi-nut driver further includes a second socket and a third socket each supported along a length of the first elongated shank, a fourth socket mounted to a first end of the second elongated shank, and a fifth socket and a sixth socket each supported along a length of the second elongated shank.

As one feature, the first socket is a reversible socket having a ¼″ socket and a 5/16″ socket. The second socket is a reversible socket having a ⅜″ socket and a 7/16″ socket. The third socket is a reversible socket having a ½″ socket and a 9/16″ socket. The fourth socket is a reversible socket having a 7 mm socket and an 8 mm socket. The fifth socket is a reversible socket having a 10 mm socket and a 12 mm socket. The sixth socket is a reversible socket having a 13 mm socket and a 14 mm socket.

In accordance with one feature of this disclosure, a multi-nut driver is provided and includes a handle having an opening and a hollow interior. The multi-nut driver includes a reversible adapter removably received in the opening of the handle. The reversible adapter includes a first retention portion at a first end, a second retention portion at a second end opposite the first end, and a third retention portion between the first end and the second end. An elongated shank is removably retainable by the first retention portion, the second retention portion, and the third retention portion. The multi-nut driver includes a socket removably mounted to the elongated shank. The elongated shank, when retained by the first retention portion, protrudes from the reversible adapter and into the hollow interior of the handle.

In one feature, the first retention portion and the second retention portion extend along a common axis extending through the length of the handle. The third retention portion extends along an axis perpendicular to the common axis.

According to another feature, the multi-nut driver further includes a second socket supported along the elongated shank. The second socket, when the elongated shank is retained by the first retention portion, is contained within the hollow interior of the handle.

As one feature, the multi-nut driver includes a second elongated shank removably retainable by the first retention portion, the second retention portion, and the third retention portion.

As another feature, the multi-nut driver includes a third elongated shank removably retainable by the first retention portion, the second retention portion, and the third retention portion.

According to one feature, the socket is a first socket further mounted to a first end of the elongated shank. The multi-nut driver further includes a second socket and a third socket each supported along a length of the elongated shank, a fourth socket mounted to a first end of the second elongated shank, and a fifth socket and a sixth socket each supported along a length of the second elongated shank.

In one feature the first socket is a reversible socket having a ¼″ socket and a 5/16″ socket, the second socket is a reversible socket having a ⅜″ socket and a 7/16″ socket, the third socket is a reversible socket having a ½″ socket and a 9/16″ socket, the fourth socket is a reversible socket having a 7 mm socket and an 8 mm socket, the fifth socket is a reversible socket having a 10 mm socket and a 12 mm socket, and the sixth socket is a reversible socket having a 13 mm socket and a 14 mm socket.

It should be understood that the inventive concepts disclosed herein do not require each of the features discussed above, may include any combination of the features discussed, and may include features not specifically discussed above.

### BRIEF SUMMARY OF THE SEVERAL VIEWS OF THE DRAWINGS

FIG. 1 is a perspective view of a multi-nut driver.

FIG. 2A is a side view of the multi-nut driver shown in FIG. 1.

FIG. 3 is a disassembled side view of the multi-nut driver shown in FIG. 1.

FIG. 4 is cross-sectional view of the multi-nut driver shown in FIG. 1.

FIG. 5 is perspective view of the disassembled multi-nut driver shown in FIG. 1.

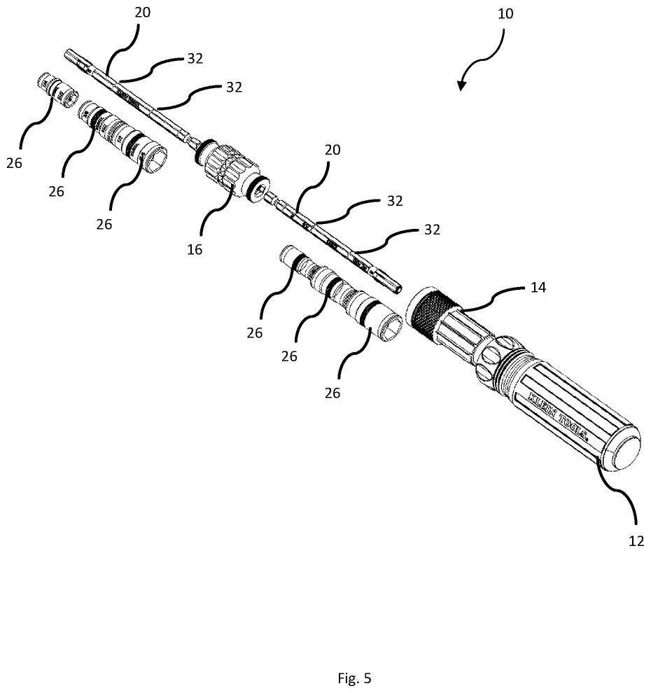

FIG. 6 is side view of an adapter portion of the multi-nut driver of FIG. 1.

FIG. 7 is a cross-sectional view of the adapter portion shown in FIG. 6.

FIG. 8 is a side view of another configuration of the multi-nut driver of FIG. 1.

FIG. 9 is a is a cross-sectional view of the multi-nut driver in the configuration of FIG. 8.

FIG. 10 a side view of a different configuration of the multi-nut driver of FIG. 1.

FIG. 11 is a cross-sectional view of yet another configuration of the multi-nut driver of FIG. 1 without the handle.

FIG. 12 is a side view of a multi-nut driver with a wrench assist collet.

### DETAILED DESCRIPTION OF PREFERRED EMBODIMENTS

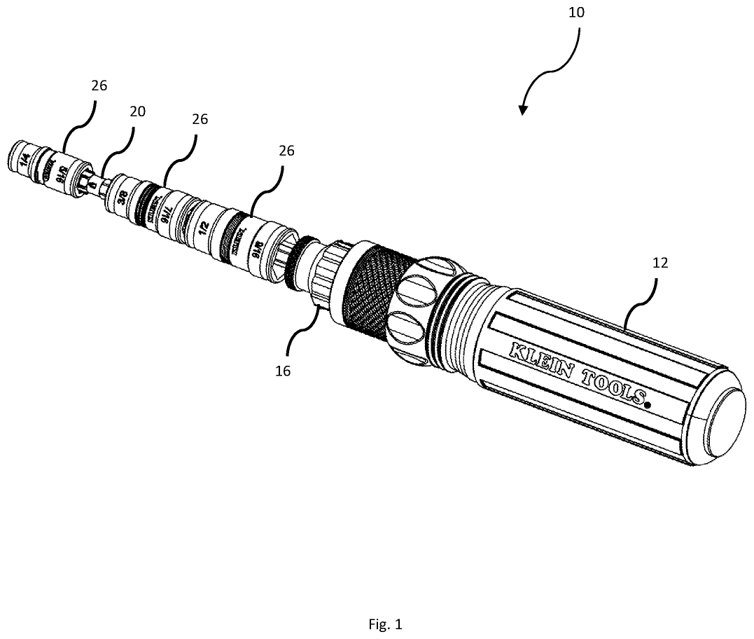

As best seen in FIG. 1, a nut driver 10 (e.g., driver) is provided. In the illustrated and preferred embodiment, the nut driver 10 is a multi-nut driver having a plurality of reversible sockets having socket ends (e.g., hex socket openings) of varying sizes, for example, to drive bolts and/or nuts having heads of varying sizes.

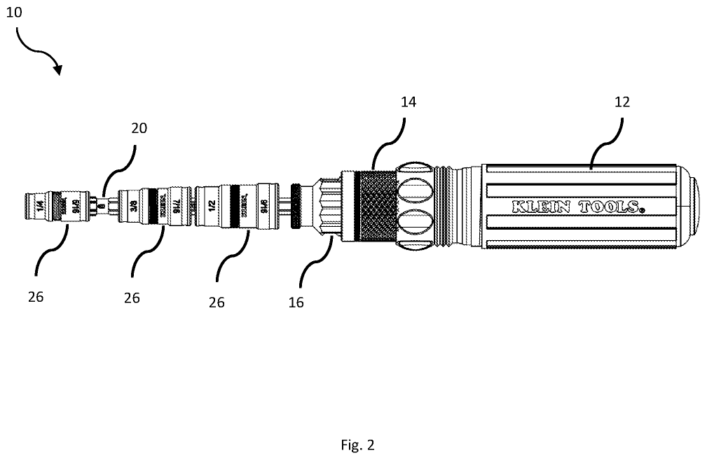

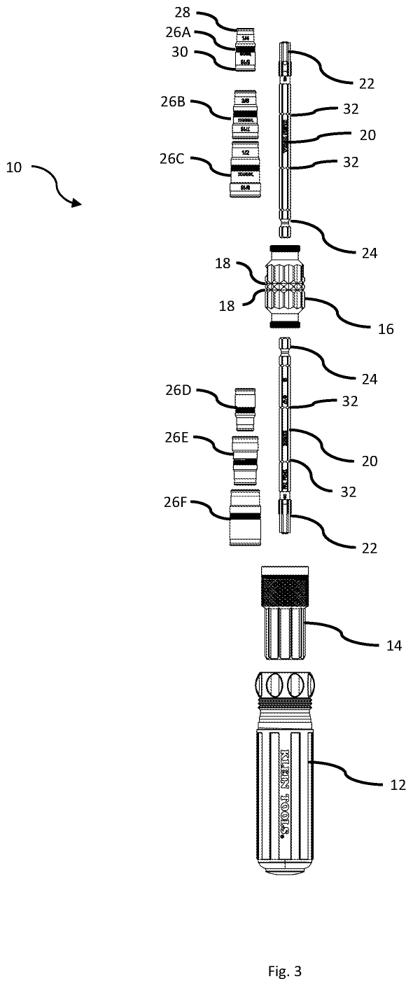

As best shown in FIGS. 2-3, the nut driver 10 includes a handle 12. The handle 12 has an elongated grip portion having an open interior and a collet 14 fit into an opening of the handle 12. In the illustrated and preferred embodiment, the collet 14 is press fit into the handle 12. In the illustrated and preferred embodiment, the collet 14 is configured to receive and retain an adapter 16 retained preferably using a ball detent. In the illustrated and preferred embodiment, the collet 14 includes a pair of balls (e.g., spheres) and springs to form the ball portion of the ball detent. The adapter 16 includes at least one grooves 18 to receive the one or more of the balls of the collet 14 to removably retain the adapter 16 within the collet 14.

In the illustrated and preferred embodiment, the nut driver 10 includes a pair of elongated drive shanks 20. The drive shanks 20 each include a socket-mounting end 22 opposite a driver engagement end 24. The driver engagement ends 24 are removably retained by the adapter 16. In the illustrated and preferred embodiment, each drive shank 20 is configured to removably retain multiple reversible sockets 26 along the length thereof. In the illustrated and preferred embodiment, drive shank 20 and reversible sockets are similar to those of US Patent Publication 20220168871, the entire disclosure of which is incorporated herein. Each socket 26 has a first end with a first hex socket opening 28 sized to engage a hexagonal profile of a first size, and a second end with a second hex socket opening 30 sized to engage a hexagonal profile of a second size. The second size is larger than the first size, and in the illustrated and preferred embodiment, the first size is ¼ inch hex socket and the second size is 5/16 inch hex socket for socket 26A. The socket 26 can be releasably mounted on the drive shank 12 in either a first orientation that presents the first hex socket opening 28 for use, or a second orientation that presents the second hex socket opening 30 for use.

While any size sockets may be used, in the illustrated and preferred embodiment, socket 26A includes a ¼″ socket and a 5/16″ socket. Socket 26B includes a ⅜″ socket and a 7/16″ socket. Socket 26C includes a ½″ socket and a 9/16″ socket. Socket 26D includes a 7 mm socket and an 8 mm socket. Socket 36E includes a 10 mm socket and a 12 mm socket. Socket 26F includes a 13 mm socket and a 14 mm socket. In the illustrated and preferred embodiment, the collet 14 includes a ⅞″ 12 point socket.

In the illustrated and preferred embodiment, each drive shank 20 a pair of storage detents 32 along the length thereof (e.g., between the socket-mounting end 22 and the driver engagement end 24). Each socket 26 includes at least one ball inside the socket 26 configured to engage the storage detents 32 to retain the sockets 26 along the length of the drive shank 20. In the illustrated and preferred embodiment, the sockets 26 may slide along the drive shank 20 from the drive engagement end 24 to engage the storage detents 32. In some embodiments, the shanks 20 each include a stop portion proximate the socket-mounting end 22 to engage the sockets 26 and prevent the sockets 26 from sliding along the length of the shank 20 to engage the storage detents 32 from the drive engagement end 24. In the illustrated and preferred embodiment, each shank 20 may engage one socket 26 at the socket-mounting end 22 for use of the socket to engage, for example, a nut or bolt. Each shank 20 may also store (e.g., retain) two sockets 26 along the length of the shank 20 while another socket 26 mounted to the socket-mounting end 22 (e.g., as shown in FIG. 2).

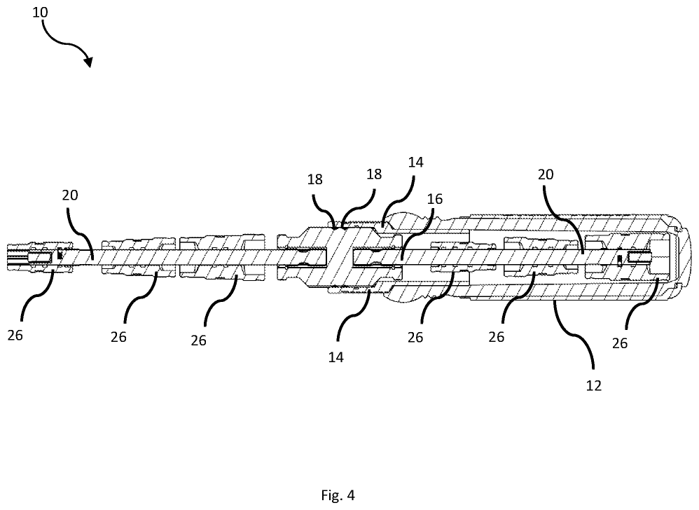

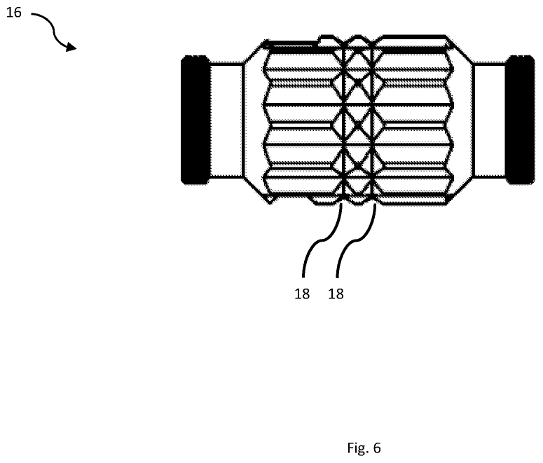

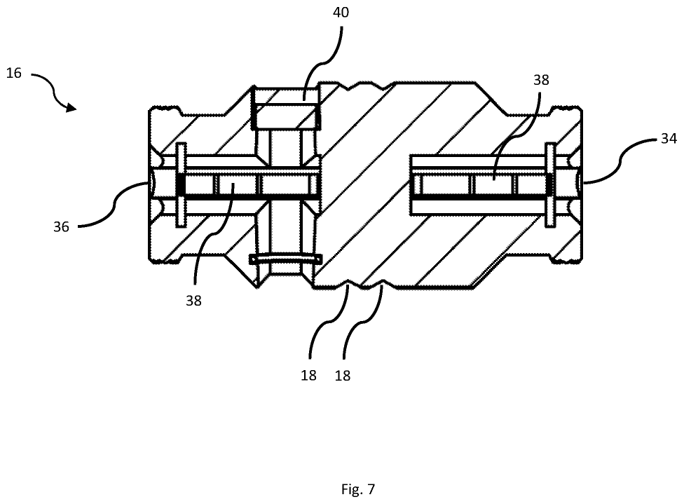

In the illustrated and preferred embodiment, the adapter 16 is configured to engage and retain the drive engagement end 24 of one or more shanks 20 in three configurations. As best shown in FIGS. 6-7, adapter 16 includes a first retention portion 34 on a first side of the adapter 16 and a second retention portion 36 on a second side of the adapter 16 opposite the first side. In the illustrated and preferred embodiment, the first retention portion 34 and the second retention portion 36 each have a leaf spring 38 to retain the drive engagement end 24 of one of the shanks 20 (e.g., as shown in FIG. 4). For example, the leaf spring 38 of the first retention portion 34 engages the drive engagement end 24 of the shank 20 when the shank 20 is inserted into the drive engagement end 24 to removably retain the engagement end 24 therein. The adapter 16 may retain one shank 20 with the first retention portion 34 while another shank 20 is retained by the second retention portion 36 (e.g., as best shown in FIG. 4).

In the illustrated and preferred embodiment, the handle 12 has an open interior. As best shown in FIG. 4, the open interior of the handle 12 is sized to enclose one of the shanks 20 and the associated sockets 26 attached thereto (e.g., along the shank). In the illustrated and preferred embodiment, the adapter 16 is insertable into the handle 12 and is engaged and retained by the collet 14. The ball(s) of the collet 14 engage one of the grooves 18 of the adapter 16 to retain the adapter 16 thereto. In the illustrated and preferred embodiment (e.g., as shown in FIG. 4), the adapter 16 may be configured to retain one shank 20 to the first retention portion 34 and another shank 20 to the second retention portion 36. In this configuration, each shank 20 may support three reversible sockets 26 (e.g., two attached along the length of the shank and one attached to the socket-mounting end 22. The adapter 16 and the attached shanks 20 and associated sockets 26 may be rotated and inserted into the handle 12 such that either one of the two shanks 20 and associated sockets 26 is contained with in the open interior of the handle 12 and the other shank 20 and associated sockets 26 protrude from the handle 12.

In the illustrated and preferred embodiment, the adapter 16 includes a third retention portion 40. The third retention portion 40 includes a c-clip and a magnet to releasably retain the driver engagement end 24 of one of the shanks 20. In the illustrated and preferred embodiment, the first retention portion 34 and the second retention portion 36 are located on opposite ends of the adapter 16. The first retention portion 34 and second retention portion 36 are positioned along a common axis allow the shanks 20 mounted in the first retention portion 34 and second retention portion to protrude from opposite ends of the adapter along the same axis. In the illustrated and preferred embodiment, the third retention portion 40 is perpendicular to the first retention portion 34 and the second retention portion 36 such that a shank 20 retained by the third retention portion 40 is perpendicular to shafts 20 retained by the first retention portion 34 and/or the second retention portion 36.

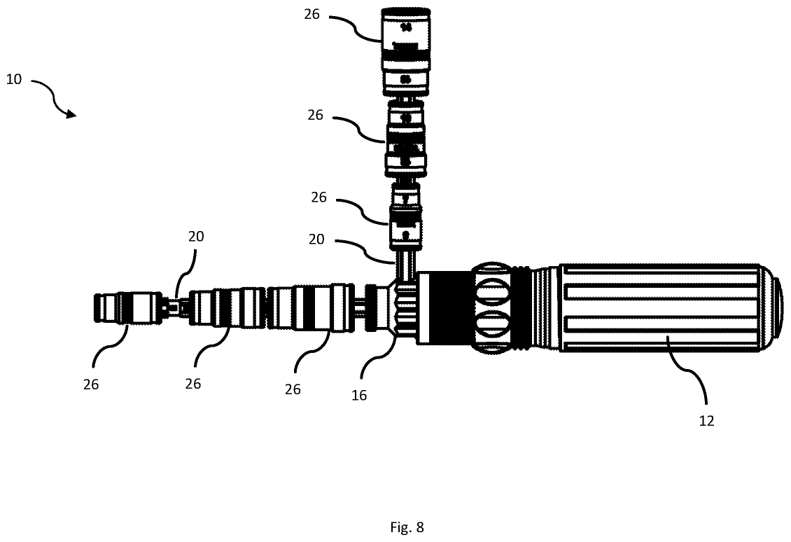

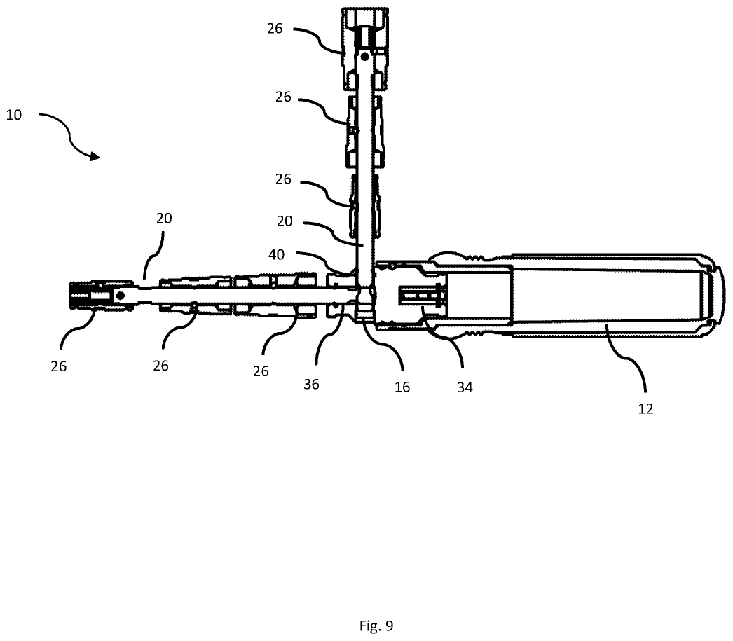

As best shown by FIGS. 8 and 9, the nut driver 10 may be arranged in a “T” configuration by inserting one shank 20 into the first retention portion 34 or the second retention portion 36 and a second shank 20 into the third retention portion 40. In this configuration, a user may find that that the handle 12 and shank 20 protruding from the first retention portion 34 or second retention portion 36 (e.g., protruding from the handle 12) allows for a users grip to generate increased torque onto the shank 20 connected to the third retention portion 40. In the illustrated and preferred embodiment, the user may store one of the shanks 20 and associated sockets 26 within the handle 12 (e.g., mounting the shank 20 to the first retention portion 34 of the second retention portion 36 and connecting the adapter 16 to the handle 12 with said shank directed towards the interior of the handle). The shank 20 and associated sockets 26 may then be removed from the first retention portion 34 or second retention portion 36 and connected to the third retention portion 40 for use.

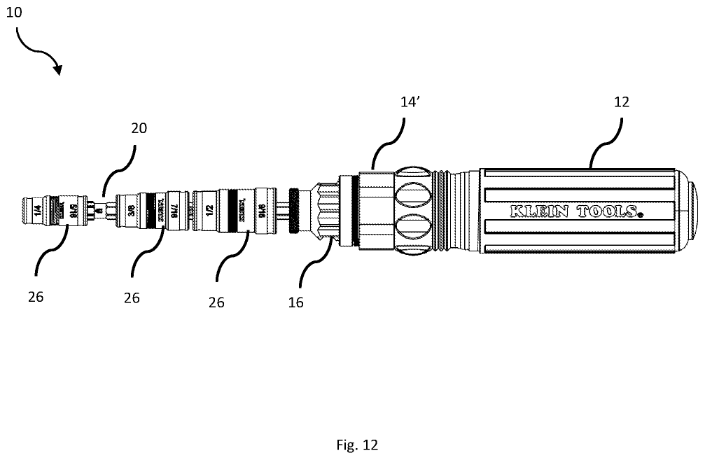

FIG. 12 shows an alternate embodiment of the nut driver 10 having a collet 14′ with a wrench assist. In the illustrated embodiment, the collet 14′ includes a hexagonal outer profile to allow a user to increase torque on the nut driver 10 by use of a wrench on the collet 14′.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the nut driver 10 are shown in the figures, it should be understood that this disclosure anticipates variations in the specific details of each of the disclosed components and features of the material dispenser and that no limitation to a specific form, configuration, or detail is intended unless expressly and specifically recited in an appended claim.

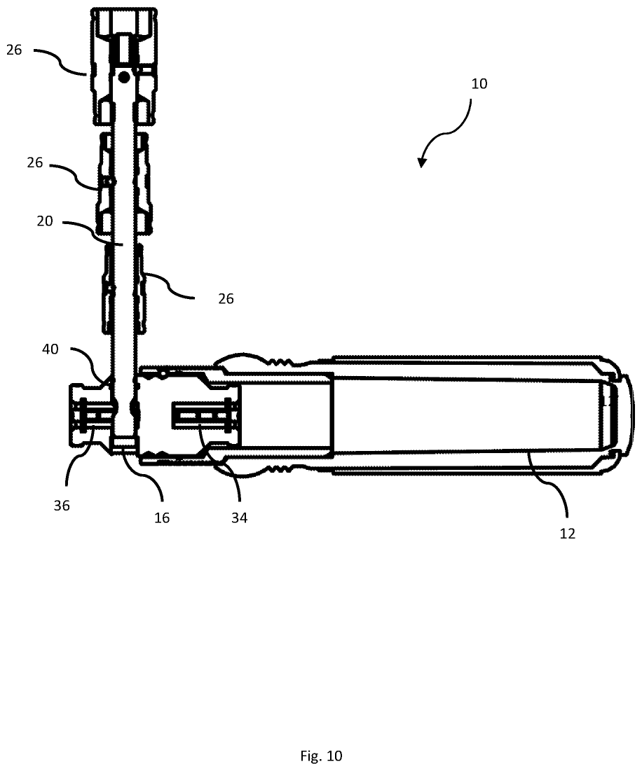

As another example, while the illustrated and preferred embodiment shown in FIGS. 8 and 9 show the nut driver 10 using two shanks, the nut driver 10 may also be used with one or three shanks. For example, FIG. 10 shows an embodiment having a single shank 20 connected to the third retention portion 40 without a shank connected to the first retention portion 34 or the second retention portion 36. The shank 20 shown in FIG. 10 may be connected to any of the first retention portion 34, second retention portion 36, or the third retention portion 40.

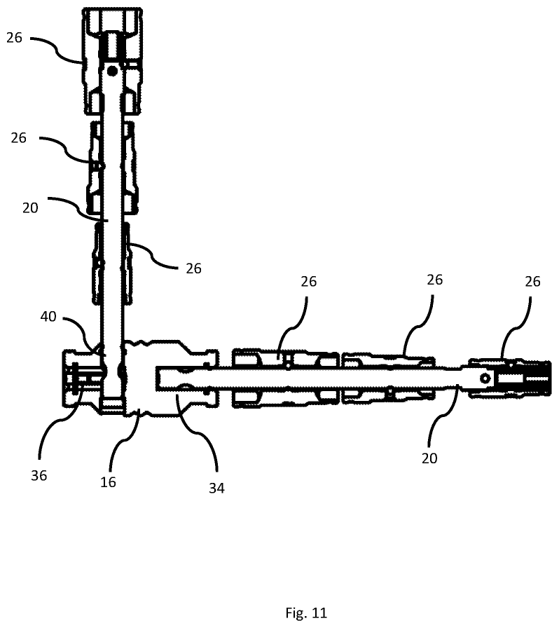

As another example, FIG. 11 shows a cross-section view of the nut driver 10 without the handle. While the shanks 20 may be connected to any of the first retention portion 34, second retention portion 36, or the third retention portion 40, FIG. 11 shows the shanks 20 connected to the first retention portion 34 and the third retention portion 40.

In a further example, while the illustrated and preferred embodiment includes three retention portions (e.g., the first retention portion 34, second retention portion 36, and third retention portion 40), some nut drivers may include only two retention portions. For example, the adapter 16 may include two adapter portions positioned along the same axis (e.g., similar to the first retention portion 34 and the second retention portion of FIG. 7) without the perpendicular third retention portion 40. In other examples, the adapter 16 may include two retention portions that are perpendicular to each other (e.g., the first retention portion 34 and the third retention portion 40 of FIG. 7 or the second retention portion 36 and the third retention portion 40 of FIG. 7).

As another example, while the illustrated and preferred embodiment shows the use of hexagonal sockets, sockets of any shape may be used (e.g., square, 12 point, etc.).

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

What is claimed is:

1. A multi-nut driver comprising:
a handle having an opening and a hollow interior;
a reversible adapter removably received in the opening of the handle, the reversible adapter including a first retention portion at a first end and a second retention portion at a second end opposite the first end;
a first elongated shank removably retained by the first retention portion;
a second elongated shank removably retained by the second retention portion;
a socket removably mounted to the first elongated shank;
wherein the first elongated shank protrudes from the reversible adapter and into the hollow interior of the handle.

2. The multi-nut driver of claim 1, wherein the handle opening is a ⅞″ hex socket shaped to engage a bolt head having a hexagonal profile.

3. The multi-nut driver of claim 1, wherein the reversible adapter includes a third retention portion on a side of the reversible adapter between the first end and the second end.

4. The multi-nut driver of claim 3, wherein the first elongated shank or the second elongated shank is removably retained by the third retention portion.

5. The multi-nut driver of claim 3, wherein the third retention portion is perpendicular to the first retention portion and the second retention portion.

6. The multi-nut driver of claim 1, wherein:
the first retention portion and the second retention portion extend along a common axis; and
the reversible adapter further includes a third retention portion extending perpendicular to the common axis.

7. The multi-nut driver of claim 1, further comprising a second socket supported along the first elongated shank, wherein the second socket is contained within the hollow interior of the handle.

8. The multi-nut driver of claim 1, wherein the socket is a first socket further mounted to a first end of the first elongated shank, the multi-nut driver further comprising:
a second socket and a third socket each supported along a length of the first elongated shank;
a fourth socket mounted to a first end of the second elongated shank; and
a fifth socket and a sixth socket each supported along a length of the second elongated shank.

9. The multi-nut driver of claim 8, wherein:
the first socket is a reversible socket having a ¼″ socket and a 5/16″ socket;
the second socket is a reversible socket having a ⅜″ socket and a 7/16″ socket;
the third socket is a reversible socket having a ½″ socket and a 9/16″ socket;
the fourth socket is a reversible socket having a 7 mm socket and an 8 mm socket;
the fifth socket is a reversible socket having a 10 mm socket and a 12 mm socket; and
the sixth socket is a reversible socket having a 13 mm socket and a 14 mm socket.

10. A multi-nut driver comprising:
a handle having an opening and a hollow interior;
a reversible adapter removably received in the opening of the handle, the reversible adapter including a first retention portion at a first end, a second retention portion at a second end opposite the first end, and a third retention portion between the first end and the second end;
an elongated shank removably retainable by the first retention portion, the second retention portion, and the third retention portion;
a socket removably mounted to the elongated shank;
wherein the elongated shank, when retained by the first retention portion, protrudes from the reversible adapter and into the hollow interior of the handle.

11. The multi-nut driver of claim 10, wherein the first retention portion and the second retention portion extend along a common axis extending through the length of the handle, and wherein the third retention portion extends along an axis perpendicular to the common axis.

12. The multi-nut driver of claim 10, further comprising a second socket supported along the elongated shank, wherein the second socket, when the elongated shank is retained by the first retention portion, is contained within the hollow interior of the handle.

13. The multi-nut driver of claim 10, further comprising a second elongated shank removably retainable by the first retention portion, the second retention portion, and the third retention portion.

14. The multi-nut driver of claim 13, further comprising a third elongated shank removably retainable by the first retention portion, the second retention portion, and the third retention portion.

15. The multi-nut driver of claim 13, wherein the socket is a first socket further mounted to a first end of the elongated shank, the multi-nut driver further comprising:
a second socket and a third socket each supported along a length of the elongated shank;
a fourth socket mounted to a first end of the second elongated shank; and
a fifth socket and a sixth socket each supported along a length of the second elongated shank.

16. The multi-nut driver of claim 15, wherein:
the first socket is a reversible socket having a ¼″ socket and a 5/16″ socket;
the second socket is a reversible socket having a ⅜″ socket and a 7/16″ socket;
the third socket is a reversible socket having a ½″ socket and a 9/16″ socket;
the fourth socket is a reversible socket having a 7 mm socket and an 8 mm socket;
the fifth socket is a reversible socket having a 10 mm socket and a 12 mm socket; and
the sixth socket is a reversible socket having a 13 mm socket and a 14 mm socket.
